(19) United States
(12) Patent Application Publication
(10) Pub. No.: US 2026/0212879 A1
(43) Pub. Date: Jul. 23, 2026

(54) Systems and Methods of Separating Audio Tracks and Matching to a Text Caption

(71) Applicant: Google LLC, Mountain View, CA (US)

(72) Inventors: Scott Thomas Wisdom, Boston, MA (US); Marco Tagliasacchi, Lugano (CH); Kevin Ian Kilgour, Lugano (CH); John Randall Hershey, Winchester, MA (US); Beat Gfeller, Zürich (CH)

(21) Appl. No.: 19/143,048

(22) PCT Filed: Dec. 30, 2022
(86) PCT No.: PCT/US2022/082634

§ 371 Date: Jun. 25, 2025

(51) Int. Cl. G10L 25/51; G06F 3/04842; G10L 25/30

(52) U.S. Cl. CPC G10L 25/51; G06F 3/04842; G10L 25/30

(57) ABSTRACT

A computer-implemented method is provided. The method includes receiving, by a computing device, an input audio waveform and an input textual description. The method further includes separating, by a neural network, the input audio waveform into a plurality of audio tracks. The method also includes determining, by the neural network, whether the input textual description describes an audio track of the plurality of separated audio tracks. The method additionally includes, upon a determination that the input textual description describes an audio track of the plurality of audio tracks, providing, by the computing device, the audio track corresponding to the input textual description to an interactive user interface.

### BACKGROUND

Many modern computing devices, including mobile phones, personal computers, and tablets, include audio capture devices, such as microphones and video cameras. The audio capture devices can capture audio from a variety of sources of audio, such as people, animals, music, background sounds, and so forth. Captured videos can include audio that can correspond to entities such as people, animals, landscapes, and/or objects.

Some audio capture devices and/or computing devices can correct or otherwise enhance an audio content. For example, some audio capture devices can provide corrections that remove artifacts such as speech distortion, bandwidth reduction, elimination and/or suppression of certain frequency bands, and so forth. After a captured audio has been corrected, the corrected audio can be saved, played, transmitted, and/or otherwise utilized.

### SUMMARY

In one aspect, a computing device may be configured to isolate arbitrary sounds in an audio. Accordingly, sound from certain sources can be enhanced, whereas sounds from other sources can be suppressed. Powered by a system of machine-learned components, an audio capture device may be configured to enable users to enhance audio content.

In some aspects, mobile devices may be configured with these features so that audio can be enhanced in substantially real-time. In some instances, audio may be automatically enhanced by the mobile device. In other aspects, mobile phone users can non-destructively enhance an audio to match their preferences. Also, for example, pre-existing audios in a user's library can be enhanced based on techniques described herein.

Accordingly, disclosed herein is a neural network that separates audio tracks in an input audio waveform and determines whether an audio track matches an input textual description or caption. In some instances, the neural network can estimate a coincidence of each separated audio track and use probabilities of such coincidences to compute an estimated audio track corresponding to the input textual description. In some aspects, a joint embedding network (also sometimes referred to as SoundWords) can be trained to embed audio and text into an embedding in a shared representation that indicates how close a particular audio embedding is to a particular text embedding. In some aspects, SoundWords may be a contrastively-trained text-audio embedding model. As described herein, a separation model may be trained to be controlled by natural language inputs, such as, for example, “remove the dog barking in the distance.” Upon receiving such an input, the trained model may separate an audio of the background comprising the barking of the dog, identify the audio track corresponding to the barking of the dog, remove or suppress the audio track corresponding to the barking of the dog, and provide the audio of the background without the barking of the dog.

In one aspect, a computer-implemented method is provided. The method includes receiving, by a computing device, an input audio waveform and an input textual description. The method further includes separating, by a neural network, the input audio waveform into a plurality of audio tracks. The method also includes determining, by the neural network, whether the input textual description describes an audio track of the plurality of separated audio tracks. The method additionally includes, upon a determination that the input textual description describes an audio track of the plurality of audio tracks, providing, by the computing device, the audio track corresponding to the input textual description to an interactive user interface.

In another aspect, a computing device is provided. The computing device includes one or more processors and data storage. The data storage has stored thereon computer-executable instructions that, when executed by one or more processors, cause the computing device to carry out operations. The operations include receiving, by a computing device, an input audio waveform and an input textual description. The operations further include separating, by a neural network, the input audio waveform into a plurality of audio tracks. The operations also include determining, by the neural network, whether the input textual description describes an audio track of the plurality of separated audio tracks. The operations additionally include, upon a determination that the input textual description describes an audio track of the plurality of audio tracks, providing, by the computing device, the audio track corresponding to the input textual description to an interactive user interface.

In another aspect, an article of manufacture is provided. The article of manufacture includes one or more computer readable media having computer-readable instructions stored thereon that, when executed by one or more processors of a computing device, cause the computing device to carry out operations. The operations include receiving, by a computing device, an input audio waveform and an input textual description. The operations further include separating, by a neural network, the input audio waveform into a plurality of audio tracks. The operations also include determining, by the neural network, whether the input textual description describes an audio track of the plurality of separated audio tracks. The operations additionally include, upon a determination that the input textual description describes an audio track of the plurality of audio tracks, providing, by the computing device, the audio track corresponding to the input textual description to an interactive user interface.

In another aspect, a system is provided. The system includes means for receiving, by a computing device, an input audio waveform and an input textual description; means for separating, by a neural network, the input audio waveform into a plurality of audio tracks; means for determining, by the neural network, whether the input textual description describes an audio track of the plurality of separated audio tracks; and upon a determination that the input textual description describes an audio track of the plurality of audio tracks, means for providing, by the computing device, the audio track corresponding to the input textual description to an interactive user interface.

In another aspect, a computer-implemented method is provided. The method includes receiving, by a computing device, training data comprising a plurality of audio clips and a plurality of textual descriptions of audio. The method further includes training, based on the training data, a neural network to: receive (i) an input audio waveform, and (ii) a textual description for an audio track, separate the input audio waveform into a plurality of audio tracks, and determine whether the input textual description describes an audio track of the plurality of separated audio tracks. The method also includes providing, by the computing device, the trained neural network.

In another aspect, a computing device is provided. The computing device includes one or more processors and data storage. The data storage has stored thereon computer-executable instructions that, when executed by one or more processors, cause the computing device to carry out operations. The operations include receiving, by a computing device, training data comprising a plurality of audio clips and a plurality of textual descriptions of audio. The operations also include training, based on the training data, a neural network to: receive (i) an input audio waveform, and (ii) a textual description for an audio track, separate the input audio waveform into a plurality of audio tracks, and determine whether the input textual description describes an audio track of the plurality of separated audio tracks. The operations also include providing, by the computing device, the trained neural network.

In another aspect, an article of manufacture is provided. The article of manufacture includes one or more computer readable media having computer-readable instructions stored thereon that, when executed by one or more processors of a computing device, cause the computing device to carry out operations. The operations include receiving, by a computing device, training data comprising a plurality of audio clips and a plurality of textual descriptions of audio. The operations also include training, based on the training data, a neural network to: receive (i) an input audio waveform, and (ii) a textual description for an audio track, separate the input audio waveform into a plurality of audio tracks, and determine whether the input textual description describes an audio track of the plurality of separated audio tracks. The operations also include providing, by the computing device, the trained neural network.

In another aspect, a system is provided. The system includes means for receiving, by a computing device, training data comprising a plurality of audio clips and a plurality of textual descriptions of audio; means for training, based on the training data, a neural network to: receive (i) an input audio waveform, and (ii) a textual description for an audio track, separate the input audio waveform into a plurality of audio tracks, and determine whether the input textual description describes an audio track of the plurality of separated audio tracks; and means for providing, by the computing device, the trained neural network.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE FIGURES

FIG. 1 illustrates an example inference phase for a neural network for separation of audio corresponding to a textual description, in accordance with example embodiments.

FIG. 2 illustrates an example training phase for a neural network for separation of audio corresponding to a textual description, in accordance with example embodiments.

FIG. 3 is a diagram illustrating training and inference phases of a machine learning model, in accordance with example embodiments.

FIG. 4 depicts a distributed computing architecture, in accordance with example embodiments.

FIG. 5 is a block diagram of a computing device, in accordance with example embodiments.

FIG. 6 depicts a network of computing clusters arranged as a cloud-based server system, in accordance with example embodiments.

FIG. 7 is a flowchart of a method, in accordance with example embodiments.

FIG. 8 is another flowchart of a method, in accordance with example embodiments.

### DETAILED DESCRIPTION

Advances in deep learning have led to some advances in audio enhancement technologies in recent years. A particular subject of interest is the problem of extracting, from a single-channel (mono) audio input, which may contain various different sounds, one or more particular sounds. The particular sounds can be described via a text input.

Described herein is a method of separating a desired sound source from an audio mixture, or a plurality of audio mixtures, based on a textual description or a caption. In some embodiments, this may be achieved by combining two models. A first sound separation model may be used to separate the audio tracks in the single-channel mixture. A second model can be trained to jointly embed both the separated audio tracks and the textual description to the same embedding in a shared representation and determine a matching score. Some conventional models perform audio separation by conditioning on the caption. However, captions do not exhaustively describe an audio, thereby resulting in noisy conditioning information. Accordingly, separation of the audio tracks followed by caption matching is helpful in reducing and/or eliminating such errors resulting in conditioning networks.

In some aspects, to enable user control of audio enhancement features, the herein-described techniques apply a model based on a neural network to adjust audio content. The herein-described techniques include receiving an input audio and predicting an output audio that enhances particular audio tracks, and/or suppresses particular audio tracks. In some examples, a trained model of the neural network can work on a variety of computing devices, including but not limited to, mobile computing devices (e.g., smart phones, tablet computers, cell phones, laptop computers), stationary computing devices (e.g., desktop computers), and server computing devices.

A neural network can be trained using a training data set of pairs of audio clips and textual descriptions of the audio clips, to perform one or more aspects as described herein. In some examples, the neural network can be arranged as an encoder/decoder neural network.

In one example, a copy of the trained neural network can reside on a mobile computing device. The mobile computing device can include a microphone that can capture input audio. The input audio may be provided to the trained neural network residing on the mobile computing device. In response, the trained neural network can generate a predicted output audio that enhances, and/or suppresses, one or more audio tracks in the input audio. A user of the mobile computing device can then listen to the output audio.

Accordingly, the mobile computing device can enhance the input audio and subsequently output the output audio (e.g., provide the output audio by an audio output device of the mobile computing device). In other examples, the trained neural network is not resident on the mobile computing device; rather, the mobile computing device provides the input audio to a remotely-located trained neural network (e.g., via the Internet or another data network). The remotely-located neural network can process the input audio and provide an output audio to the mobile computing device. In other examples, non-mobile computing devices can also use the trained neural network to modify audio.

As such, the herein-described techniques can improve audio by applying more desirable and/or selectable audio enhancements, thereby enhancing the actual and/or perceived quality of the audio. Enhancing the actual and/or perceived quality of audio can therefore provide benefits by making audio sound clearer, and free of certain background sounds. These techniques are flexible, and so can apply a wide variety of audio enhancements that include arbitrary sound sources.

### Introduction and Overview

Mixed audio tracks are common in various environments. For example, common street sounds can include a variety of individual tracks. Also, for example, commentary at a stadium, and/or rulings made by a referee, umpire, etc. may be drowned out by cheering crowds. Although an individual may be able to separate the various sounds, a computer may struggle at this task, especially if the audio is only provided as a single channel input and the goal is to focus on an arbitrary sound, e.g., the commentary, or a particular street sound.

Generally, when a type of audio to focus on is known in advance, dedicated enhancement algorithms may be trained to separate that audio. In some instances, systems may be built to enhance speech, and/or extract audio corresponding to individual musical instruments. There are also models that may address universal sound separation, where the goal is to split a single channel audio mixture into its individual component signals regardless of their class. Such methods may be utilized followed by a subsequent selection step that picks which component signal the user may want to focus on. While this approach may be somewhat more versatile than having a set of predefined target classes, it typically involves estimation of each separate sound in the mixture, thereby making the user interface more complicated and using more computational resources as compared to enhancing only one type or class of target sound.

Some existing methods are based on conditioning a behavior of a neural sound separation model to exploit additional information present in modalities other than audio. In particular, audio-visual methods for specific tasks such as speech enhancement, and separating limited sets of classes such as musical instruments, may be used. Audio-visual universal separation models can also be trained to separate all sounds that originate from visible on-screen objects. Other examples of conditioning inputs may include accelerometer data to improve speech enhancement, target speaker embedding for speech separation, or sound class for universal separation, using either a vector indicating desired one or more source classes, or an audio clip from a desired class of sound. Conditioning may be generally performed by injecting a sound separation network with embeddings extracted from the conditioning input.

Universal sound separation, such as a task of separating all sounds from an acoustic mixture regardless of class, may be achieved with supervised data. Some weakly supervised methods can use sound class as weak labels. In some instances, completely unsupervised methods can learn directly from raw mixtures of sounds. Some example universal sound separation models may be conditioned based on images, audio, and/or text. However, such conditioning may result in an ambiguity as to how specifically the model may interpret the provided conditioning. For example, if the model is provided with an image of an owl hooting, it may not be clear for the model as to whether it may focus on all bird sounds, on sounds made by owls only, or sounds made by this particular individual owl. Also, for example, it may not be clear for the model as to whether it may focus on hooting sound made by the owl, but not other sounds such as, for example, a flapping sound made by the owl. Similar types of ambiguities may arise when the conditioning is based on audio only. There may be additional complexities in audio conditioning, as some types of sound may change greatly over time. For example, the starting noise of an engine is not the same as a constant purr when the engine is running.

Text conditioning for separation models generally relies upon a textual transcript of a target audio track. For example, text-informed nonnegative matrix factorization for speech separation can be performed. As another example, lyric-informed singing voice separation can also be performed. Some computer vision models involve joint image and natural language embedding models. Rather than relying on fixed ontologies, such models provide a natural interface to support cross-modal retrieval and zero-shot classification applications. Also, for example, some joint embedding models are built on top of separately trained and fixed neural audio and text embeddings. Although such joint embeddings have been evaluated on a cross-modal retrieval task, the models have not been considered in a separation or generative audio application.

In some instances, separation of arbitrary sounds from a mixture, known as “universal sound separation,” may be achieved for a fixed number of sounds. Conditional information about which sound classes are present can improve separation performance. Availability of the Free Universal Sound Separation (FUSS) dataset has expanded the scope to separate a variable number of sounds, which can then be used to handle more realistic data. Also, for example, specific sound classes may be extracted from input sound mixtures. Such approaches typically use curated data containing isolated sounds for training, which limits their application to truly open-domain data, and introduces challenges such as, for example, annotation cost, accurate simulation of realistic acoustic mixtures, and/or biased datasets. Some of these challenges may be overcome by replacing strong supervision of reference source signals with weak supervision labels from related modalities such as sound class, visual input, or spatial location from multi-microphone recordings.

Generally, a universal sound separation process is more effective when the audio tracks are first separated prior to determining a match with a textual description. Accordingly, there is a need for a text-driven machine learning based universal sound separation model, where single channel sound is first separated, and the separated tracks are matched with a textual description. For example, given any input audio, one or more audio tracks in an input mixture can be separated, and probability scores indicative of audio correspondence for each separated track can be estimated. A higher probability score is indicative of separated sources that correspond to a textual description, and a lower probability score is indicative of separated sources that do not correspond to the textual description. The separated audio tracks, weighted by their estimated probabilities, can be summed together to reconstruct the audio mixture. Since real-world audios can contain an unknown number of audio tracks belonging to an undefined ontology of classes, machine learning models disclosed herein provide an effective solution to the text-to-audio matching problem. In some embodiments, an embedding model may be trained to co-embed audio clips and their textual descriptions close together in the same embedding space. Machine learning models disclosed herein do not restrict the domain of audio, such as, for example, to musical instruments or human speakers.

### Network Architecture

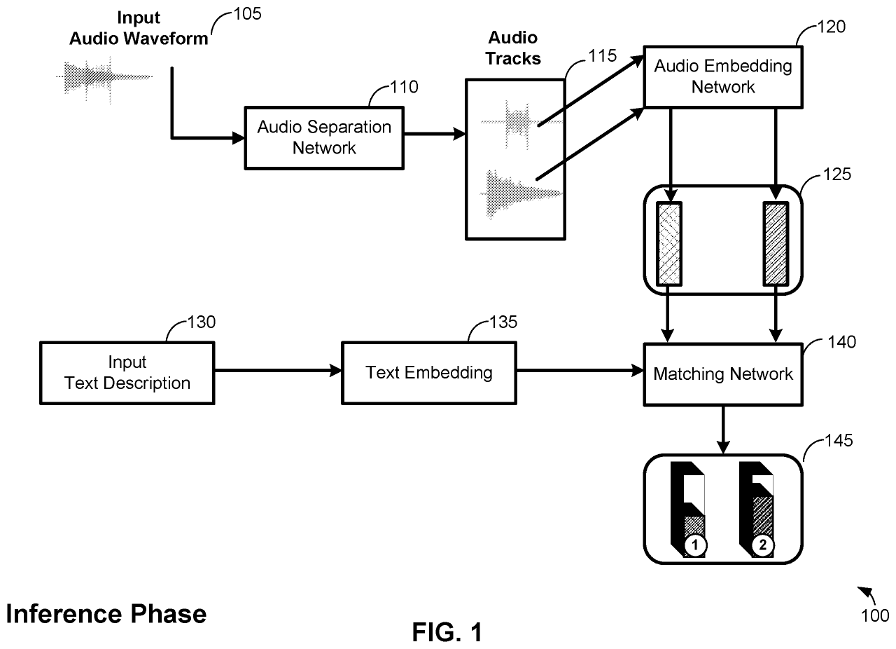

FIG. 1 illustrates an example inference phase 100 for a neural network for separation of audio corresponding to a textual description, in accordance with example embodiments. In some embodiments, a computing device can receive an input audio waveform 105 and an input text description 130. Input audio waveform 105 may be input to audio separation network 110. In some embodiments, the audio separation network 110 identifies one or more estimated audio tracks in input audio waveform 105. For example, input audio waveform 105 may be a mixture of a plurality of audio tracks. Audio separation network 110 estimates the plurality of audio tracks in input audio waveform 105.

An example architecture for audio separation network 110 may include learnable convolutional encoder and decoder layers. For example, each input audio waveform 105 may be 2.5 milliseconds (ms) of audio, and can be represented by a number of coefficients that capture audio features in an encoded mixture of input audio waveform 105. Some embodiments may use short-time Fourier transforms as a representation. In some embodiments, audio separation network 110 may process these coefficients and predict a mask, which is another neural representation of input audio waveform 105. The mask may be multiplied with the coefficients, and an inverse transform may be applied to generate a number of estimated audio tracks, or tracks 115.

In some implementations, a mixture consistency projection can be applied to constrain separated sources to add up to the input mixture. Audio separation network 110 may process a T-sample input mixture waveform and output estimated audio tracks 115. For example, M estimated audio tracks, ŝₘ, m=1, . . . , M, may be output as vectors of length M×T, where ŝ ∈R^{M×T} The masking network estimates M masks which are multiplied with the activations of the encoded version of input audio waveform 105. The final time-domain signals ŝ may be computed by applying a decoder (e.g., a transposed convolutional layer), to the masked coefficients.

In some embodiments, the neural network includes an audio embedding network 120 to generate an audio embedding comprising a representation of audio features in the estimated audio tracks 115. For each separated source m, a time-domain audio sample ŝₘ, m=1, . . . , M, may be generated. Accordingly, a corresponding audio embedding can be generated using a neural network. For example, audio embedding network 120 may be run on a Mel spectrogram (e.g., 1-second patches) to obtain time-varying audio embeddings of the audio tracks. In some embodiments, a MobileNet v1 architecture may be used for audio embedding network 120. Such an architecture can include a stacked two-dimensional (2D) separable dilated convolutional blocks with a dense layer at the end. In some embodiments, a ResNet architecture may be used for audio embedding network 120. Additional, and/or alternative audio embedding architectures may be used.

The audio embedding network 120 generates one or more audio embeddings 125. The input text description 130 is input to a text embedding network to generate a text embedding 135. In some embodiments, input text description 130 may be a natural language description of the audio clip. For example, an audio clip for a hoot of an owl may be associated with a textual description “hooting of an owl,” “an owl hooting,” “owl hoot,” and so forth. As may be noted, there may be a plurality of audio clips for each type of sound. For example, an audio clip for an owl hooting may include audio clips of varying length from a single audio recording, audio clips corresponding to the same owl but at different times, and/or locations, audio clips corresponding to different owls, and so forth.

Also, for example, a textual description “owl hoot” may be associated with one or more audio clips corresponding to an owl hooting. However, a textual description “hooting horn” may be associated with one or more audio clips of a sound made by a horn of a car, such as, for example, a blaring sound, a blasting sound, a tooting sound, and so forth. As another example, “hoot with laughter” may be associated with one or more audio clips of human sounds corresponding to scorn, disapproval, merriment, and so forth.

A classifier 140 can match the text embedding 135 to the one or more audio embeddings 125 to determine whether there is a match. For example, classifier 140 outputs a probability score for each estimated audio track 115 individually, and assigns a value between 0 and 1. The probability score is indicative of a likelihood that a given estimated audio track corresponds to the input text description 130. A higher probability is indicative of a higher likelihood that the given estimated audio track corresponds to the input text description 130, whereas a lower probability is indicative of a lower likelihood that the given estimated audio track corresponds to the input text description 130. Accordingly, classifier 140 can generate a label or ranking 145 indicative of whether a given estimated audio track corresponds to the input text description 130.

In some implementations, a threshold probability score may indicate whether a given estimated audio track corresponds to the input text description 130. For example, a probability score that exceeds the threshold probability score is indicative of a match with the input text description 130, whereas a probability score that does not exceed the threshold probability score is not indicative of a match with the input text description 130. Generally, the threshold probability score may depend on a number of factors, such as, for example, audio features, such as a type of sound, a type of source, a quality of audio, a type of environment, and so forth. Also, for example, in some implementations, separated audio tracks in a given audio waveform may be associated with one threshold probability score. In some other implementations, more than one threshold probability score may be used for a given audio waveform. Also, for example, the threshold probability score may be a learnable parameter of a neural network.

In some embodiments, based on whether a particular audio track of the one or more estimated audio tracks corresponds to the input text description 130, the computing device can modify an audio content of a particular audio track associated with the input text description 130. Also, for example, upon a determination that a separated audio track does not correspond to the input text description 130, the computing device can suppress this audio track. In some embodiments, upon a determination that a separated audio track does not correspond to the input text description 130, the computing device can provide this audio track to a user via an interactive user interface. Also, for example, the computing device can provide a user selectable option to enhance or suppress such an audio track. In some embodiments, upon a determination that a separated audio track does not correspond to the input text description 130, the computing device can provide a notification to a user via the interactive user interface that an audio track does not correspond to the input text description 130. Once the audio track is enhanced or suppressed, it can be mixed in to recreate a mixture of soundtracks, and the computing device can provide the modified audio content to an interactive user interface using the computing device.

In some embodiments, the computing device can receive two or more textual descriptions and identify audio tracks that correspond to each of the two or more textual descriptions. Generally, such correspondence may be one-to-many. For example, a first textual description may correspond to a first set of separated audio tracks, and a second textual description may correspond to a second set of separated audio tracks. The computing device may separate such audio tracks and label them. For example, the computing device may label the first set of separated audio tracks with the first textual description, and/or label the second set of separated audio tracks with the second textual description. Additionally, and/or alternatively, the computing device may label any remaining separated audio tracks as not corresponding to the first and second textual descriptions. The interactive user interface may be configured to provide user-friendly tools to enable a user to select the separated audio tracks and to indicate which, if any, audio tracks are to be enhanced or suppressed. The terms enhance or suppress, as used herein, can generally refer to modifying a signal corresponding to an audio track to adjust one or more frequencies (e.g., for treble, bass, etc.), to modify a volume, to remove noise from the signal, to add a time delay or a shift to the signal, to repeat or delete certain portions of the signal, and so forth. In some embodiments, the user may be provided with an ability to input whether the audio track corresponding to the textual description has been correctly identified. Such user feedback may be used as labeled data to train the neural networks (e.g., classifier) described here.

In some embodiments, the computing device (e.g., a mobile device) can generate a request to determine whether the input textual description describes an audio track in an input waveform. Then, the computing device (e.g., a mobile device) can send the request from the computing device (e.g., a mobile device) to a second computing device (e.g., a cloud server). The second computing device (e.g., a cloud server) can include a trained version of the neural network. Subsequently, the computing device (e.g., a mobile device) can receive, from the second computing device (e.g., a cloud server), the determination of whether the input textual description describes an audio track in an input waveform. Then, the computing device (e.g., a mobile device) can output a modified version of the waveform (e.g., by enhancing the audio track corresponding to the input textual description, and/or suppressing the audio track corresponding to the input textual description). In some embodiments, the computing device can include a microphone and generate the audio content using the microphone.

In some embodiments, the providing of the audio track involves providing, by the interactive user interface, a user selectable option to enhance or suppress the audio track corresponding to the input textual description. For example, an interactive user experience may be provided in which a user can adjust an audio content for an input audio waveform. This provides additional creative flexibility to users to find their own balance between sounds from different audio tracks based on a textual description that describes one or more of the audio tracks. For example, when the audio captures a conversation between two individuals, the computing device can separate the audio tracks (e.g., each individual as an audio track). A user may be presented, via an interactive graphical user interface, with an option to enhance or suppress a separated audio track that matches a given textual description (e.g., a name of a speaker). In some embodiments, speech recognition techniques may be applied to identify a speaker. A user may indicate selection of one individual, and the computing device may enhance the audio track corresponding to the selected individual, and/or suppress the audio track corresponding to the other individual. Also, for example, aspects of audio enhancement can be applied to existing audio files from a user's library. Although the example illustrates enhancement and/or suppression of an audio track corresponding to an individual, similar techniques may be applied to other audio tracks. In some embodiments, For example, a music composition may include audio tracks corresponding to different instruments. A user may input a textual description that corresponds to a name of an instrument (e.g., plano, viola, lead guitar, and so forth). The techniques described herein may be applied to separate the music composition into the audio tracks, and the audio track corresponding to the textual description may be identified. Subsequently, the user may be presented, by the interactive user interface, an option to enhance or suppress the separated audio track that matches the textual description.

In some embodiments, the receiving of the input audio waveform and the input textual description involves receiving the input textual description from a user via the interactive user interface. For example, the interactive user interface may be an audio interface, and a user may input (e.g., using a microphone of the computing device) the textual description of an audio track. Also, for example, the interactive user interface may be a text input interface, and a user may input (e.g., using a text input medium such as a keyboard) the textual description of an audio track.

In some embodiments, the receiving of the input audio waveform and the input textual description involves receiving the input audio waveform via the interactive user interface. For example, the interactive user interface may be an audio interface communicatively linked to a microphone of the computing device, and the input audio waveform may be recorded using the microphone. In some embodiments, the recorded audio may be saved in a library. Audio separation may be performed in real-time as the input audio waveform is recorded, or audio separation may be performed on the recorded audio file.

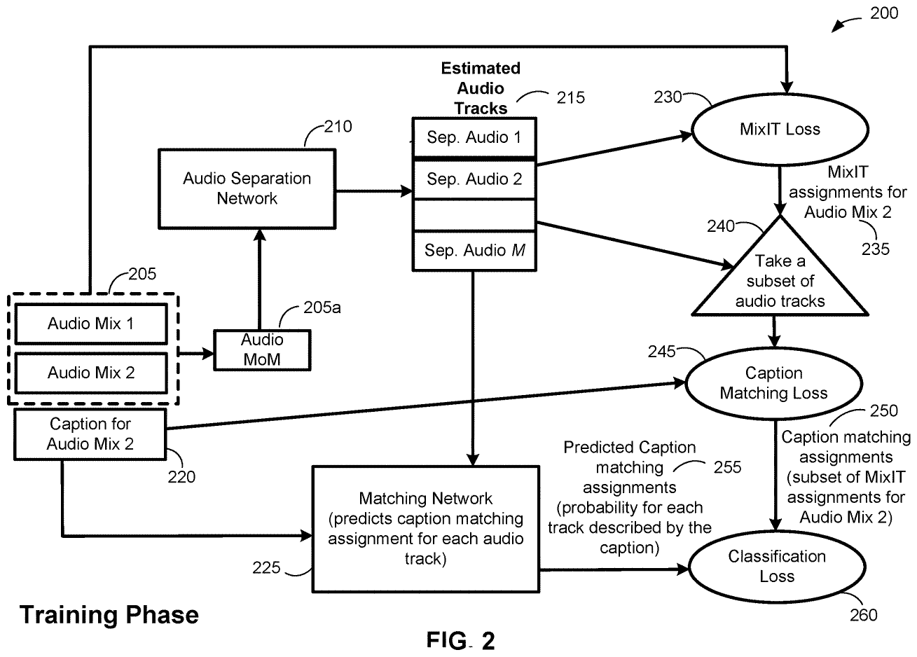

FIG. 2 illustrates an example training phase 200 for a neural network for separation of audio corresponding to a textual description, in accordance with example embodiments. In some embodiments, the neural network may be a fully-convolutional neural network as described herein. During training, the neural network can receive as inputs one or more input training datasets. Neural network can include layers of nodes for processing input audio and input text. Example layers can include, but are not limited to, input layers, convolutional layers, activation layers, pooling layers, and output layers. Input layers can store input data, such as audio features of input audio and inputs from other layers of the neural network. Convolutional layers can compute an output of neurons connected to local regions in the input. In some examples, the predicted outputs can be fed back into the neural network again as input to perform iterative refinement. Activation layers can determine whether or not an output of a preceding layer is “activated” or actually provided (e.g., provided to a succeeding layer). Pooling layers can downsample the input. For example, the neural network can involve one or more pooling layers downsampling the input by a predetermined factor (e.g., a factor of two) in the horizontal and/or vertical dimensions. Output layers can provide an output of the neural network to software and/or hardware interfacing with the neural network; e.g. to hardware and/or software used to display, print, communicate and/or otherwise provide an enhanced audio.

For purposes of illustration, audio waveform 205 may be a mixture of one or more audio tracks. In some embodiments, audio waveform 205 may include a plurality of audio mixes, Audio Mix 1, Audio Mix 2, and so forth. Some audio tracks may be filtered out during pre-processing, and so forth. Also, for example, an audio mixture of mixtures (MoM) 205a can be generated by mixing the plurality of audio mixes, Audio Mix 1, Audio Mix 2, and so forth. Audio MoM 205a may be input into audio separation network 210. Audio separation network 210 may share one or more aspects in common with audio separation network 110.

Audio separation network 210 may separate audio MoM 205a into estimated audio tracks 215. As indicated, estimated audio tracks 215 may include separated audio tracks, Sep. Audio 1, Sep. Audio 2, . . . , Sep. Audio M. In some embodiments, each separated audio track from estimated audio tracks 215 may be input to an audio embedding network. The audio embedding network may share one or more aspects in common with audio embedding network 120. The audio embedding network may generate one or more audio embeddings, where each audio track Sep. Audio 1, Sep. Audio 2, . . . , Sep. Audio M from estimated audio tracks 215 corresponds to a respective, separate audio embedding. For illustrative purposes, Sep. Audio 1, Sep. Audio 2, . . . , Sep. Audio M may represent the separated audio tracks, and/or the audio embeddings.

The input text description 220 may be a caption for Audio Mix 2. In some embodiments, input text description 220 may be input to a text embedding network to generate a text embedding. In some embodiments, input text description 220 may be a natural language description of an audio track. For illustrative purposes, input text description 220 may represent a textual input and/or a text embedding for the textual input. A matching network 225 can match the input text description 220, such as the caption for Audio Mix 2, to separated audio tracks 215, such as, Sep. Audio 1, Sep. Audio 2, . . . , Sep. Audio M to determine whether there is a match. In some embodiments, the text embedding may be matched to the one or more audio embeddings to determine whether there is a match. For example, matching network 225 may output a probability score for each estimated audio track 215 individually, and assign a value between 0 and 1. The probability score is indicative of a likelihood that a given estimated audio track such as, Sep. Audio 1, Sep. Audio 2, . . . , Sep. Audio M corresponds to the input text description 220, such as the caption for Audio Mix 2. A higher probability is indicative of a higher likelihood that the given estimated audio track corresponds to the input text description 220, whereas a lower probability is indicative of a lower likelihood that the given estimated audio track corresponds to the input text description 220. Accordingly, matching network 225 can generate a label or ranking indicative of whether a given estimated audio track corresponds to the input text description 220. In some embodiments, additional and/or alternative captions may be input. For example, input text description 220 may be a caption for Audio Mix 1, and the model may be trained on this caption. In some embodiments, more than one caption may be input. For example, a first caption for caption for Audio Mix 1 and a second caption for caption for Audio Mix 2 may be provided.

For example, Sep. Audio 1 may be associated with a relatively higher probability score. Similarly, Sep. Audio 2 may be associated with a relatively lower probability score. Accordingly, the neural network predicts that Sep. Audio 1 likely corresponds to the input text description 220, whereas Sep. Audio 2 likely does not correspond to the input text description 220.

In some embodiments, the training of the neural network may include unsupervised mixture invariant training (MixIT). In particular, the training may involve determining a MixIT Loss 230, which only relies on audio information. For example, MixIT Loss 230 may involve comparing estimated audio tracks 215 with input audio waveform 205 to minimize losses. For example, a sum of the estimated audio tracks 215 may be determined and compared to the input audio waveform 205 to determine whether all audio tracks in input audio waveform 205 are accounted for.

For example, the neural network can be trained with a MixIT loss 230, which measures fidelity between sums of separated sources (e.g., estimated audio tracks 225) specified by the MixIT assignment (e.g., MixIT assignment 235 for Audio Mix 2) and reference mixtures (e.g., input audio waveform 205). For example, MixIT separation loss 230 may be utilized to optimize an assignment of estimated audio tracks, to two reference mixtures and as follows:

$${L}_{sep} ( {x}_{1} , {x}_{2} , \hat{s} ) = ( {L}_{SNR} ( {x}_{1} , {[ A \hat{s} ]}_{1} ) + {L}_{SNR} ( {x}_{2} , {[ A \hat{s} ]}_{2} ) ) , \qquad ( Eqn . 1 )$$

where a mixing matrix A∈B^{2×M} is constrained to a set of 2×M binary matrices, where each column adds up to 1. Due to the constraints on A, each source ŝₘcan only be assigned to one reference mixture. In some embodiments, audio separation network 210 can be pre-trained with mixture invariant training (MIxIT) on a large amount of data, which is a method for training separation models on raw audio mixtures.

In some embodiments, the neural network may be trained on a caption matching loss 245 based on differences between the one or more estimated audio tracks 215 and the input textual description 220. For example, various subsets of separated tracks 215 may be determined. For each such subset, a sum of the respective audio tracks may be input to an audio embedding network to generate an audio embedding for each subset of tracks. Subsequently, distances between the text embedding of the caption and the respective audio embeddings for each subset of tracks may be determined, for example in a shared representation generated by a joint embedding network. At block 240, a subset of the separated audio tracks may be selected from the estimated audio tracks 215, where the subset minimizes the distance between the text embedding of the caption and the respective audio embedding corresponding to the selected subset.

The input textual description 220 may then be compared to the subset of the separated audio tracks to determine a caption matching loss 245. In some embodiments, the caption matching loss 245 can account for textual caption matching losses. Generally, the training of the neural network involves minimizing the caption matching loss 245 so that the captions can provide a more accurate match with a separated audio track.

Generally, caption matching loss 245 cannot be computationally intensive. For example, because there are M separated audio tracks, the possible combinations of subsets will be of the order of 2 \hat{ }M. In some embodiments, a smaller joint embedding network may be trained to identify the subset that minimizes the distance. For example, a trained model may recognize one or more relationships between an audio embedding for a separated audio track and an audio embedding for an audio mix that includes the separated audio track. Such a relationship may be leveraged in training the smaller joint embedding network.

In some embodiments, Audio Mix 1 may also be associated with a caption. Accordingly, the caption matching loss 245 may be applied based on the caption for Audio Mix 1 to ensure that there is no overlap between the respective assignments for the caption matching for Audio Mix 1 and the caption matching for Audio Mix 2. This may provide an additional training example to train matching network 225.

In some embodiments, the neural network may be trained on a classification loss 260. For example, one or more caption matching assignments 250 can be compared to predicted caption matching assignments 255. For example, the one or more caption matching assignments 250 may be a subset of the MixIT assignments 235 for Audio Mix 2. Also, for example, the predicted caption matching assignments 255 may be a set of probabilities generated by the matching network 225, where the probabilities are indicative of a likelihood that a separated audio track corresponds to the caption for Audio Mix 2. A classification loss 260 may indicate a degree to which the caption matching assignments 250 match the predicted caption matching assignments 255. Generally, the training of the neural network involves minimizing the classification loss 260 so that the predicted matches are more consistent with the caption matching assignments.

In some embodiments, training data comprising a plurality of audio mixes and a plurality of textual descriptions of audio, may be received. For example, a dataset comprising pairs of audio mixes and a textual description may be received. The audio mixes may be audio samples of a sound, such as, for example, an animal sound, a bird sound, a sound made by an instrument, engine sounds of various types of vehicles, sound of water in different settings, human voices and other sounds made by humans, nature sounds, and so forth. As a labeled example, an audio track in each audio mix may be associated with a text description of audio.

In some embodiments, extraction of audio may be performed by a model that includes one or more components. In some embodiments, the audio embedding network and the text embedding network may be components of (or integrated into) a joint embedding network that generates a shared representation comprising a joint embedding, where an audio embedding of a given audio track is within a threshold distance of a text embedding of a textual description of the given audio track. In some embodiments, the joint embedding network may be a frozen network. For example, a sound extraction model may include a joint embedding network that takes an input vector based on text or audio and computes the corresponding embedding. For example, the joint embedding network may be trained on a pair, (audio, text), that may include a wide range of scales, supervisory quality, and language usage patterns. As an illustrative example, a first collection of approximately 50 million, 10-second sound clips extracted from randomly selected internet videos (1 clip/video) may be utilized. The associated text may be names and natural language descriptions of knowledge graph entities associated with each video.

As another illustrative example, a second collection may be samples from an AudioSet dataset that includes approximately 2 million, 10-second audio clips. This dataset covers approximately 527 sound event categories. For example, AudioSet consists of an expanding ontology of 332 audio event classes and a collection of 2,084,320 human-labeled 10-second sound clips drawn from YouTube videos. The ontology is specified as a hierarchical graph of event categories, covering a wide range of human and animal sounds, musical instruments and genres, and common everyday environmental sounds. In some aspects, the natural language diversity here may be limited with only one or two label variations per class. The associated text may include (i) standard human-readable labels associated with each audio clip in the dataset; (ii) a set of human-provided natural language sound descriptions that may be collected (e.g., approximately 50K of the AudioSet clips); and (iii) the AudioCaps dataset which includes natural language descriptions for approximately 46K AudioSet clips. AudioCaps is a large-scale dataset of about 46K audio clips to human-written text pairs collected via crowdsourcing on the AudioSet dataset.

As another example, a third collection may include approximately 110K sound events and/or scene recordings from a library, such as Pro Sound Effects Library. Each recording may be paired with a textual description. In some embodiments, the textual description may be an unstructured list of tags, a multiple-sentence natural language description, and so forth.

Generally, the two models, audio separation network 210 and the joint embedding network (e.g., comprising an audio embedding network and a text embedding network), may be trained separately, as they may involve different types of training data. For example, the joint embedding network may be trained on audio samples paired with respective textual descriptions, and audio separation network 210 may be trained with single channel audio mixtures.

In some embodiments, based on the training data, the neural network may be trained to: receive (i) an input audio waveform 205, and (ii) a textual description 220 for an audio track, separate the input audio waveform into a plurality of audio tracks, and determine whether the input textual description describes an audio track of the plurality of separated audio tracks. For example, the neural network may receive an input audio waveform 205 from which one or more audio tracks are to be separated, or filtered out. In some embodiments, the input audio waveform 205 may be a single channel mixed audio. For example, the input audio waveform 205 may be a single channel audio that includes one or more audio tracks, such as, a car horn, a hooting of an owl, human voices in a nearby store, and a sound of a car engine. Also, for example, the neural network may receive a textual description 220 of an audio track. For example, the neural network may receive a text input such as “car engine.” In some embodiments, the audio separation network 210 may separate the audio tracks into estimated audio tracks 215, and may embed the text input 220 in a shared representation (e.g., by using a joint embedding network).

In some embodiments, the training of the neural network may involve training the neural network to generate, from the input audio waveform, first audio corresponding to a text description (e.g., as an enhanced output), and generate, from the input audio waveform, second audio that does not correspond to the text description (e.g., as a suppressed output).

In some embodiments, the generating of the shared representation includes training the joint embedding network. The training of the joint embedding network may be based on training data comprising a plurality of pairs, each pair comprising an audio clip and a textual description of the audio clip. For example, audio clip and a textual description of the audio clip may be received. The audio clip may be an audio sample of a sound, such as, for example, an animal sound, a bird sound, a sound made by an instrument, engine sounds of various types of vehicles, sound of water in different settings, human voices and other sounds made by humans, nature sounds, and so forth. Each audio clip may be associated with a textual description. Accordingly, the plurality of pairs may be “(audio clip, textual description).” Such a pairing is generally a many to many mapping. In other words, each audio clip may be paired with a plurality of textual descriptions, and each textual description may correspond to a plurality of audio clips.

In some embodiments, the textual description may be a natural language description of the audio clip. For example, an audio clip for a hoot of an owl may be associated with a textual description “hooting of an owl,” “an owl hooting,” “owl hoot,” and so forth. Accordingly, the plurality of pairs may include “(audio clip for owl hooting, hooting of an owl),” or “(audio clip for owl hooting, owl hoot),” and so forth. As may be noted, there may be a plurality of audio clips for each type of sound. For example, an audio clip for an owl hooting may include audio clips of varying length from a single audio recording, audio clips corresponding to the same owl but at different times, and/or locations, audio clips corresponding to different owls, and so forth. Also, for example, a textual description may describe a plurality of audio clips.

In some embodiments, the joint embedding network may be a joint embedding model of natural language and sound that includes dedicated towers for each, but that may be trained to terminate in the same target space. Similar to existing techniques, contrastive learning may be performed using a large set of audio clips paired with associated natural language descriptions. By applying a contrastive multi-view coding loss function the learned embedding acts to co-locate, in the same target space, audio and its underlying semantic categories expressed via freeform natural language.

In some embodiments, training of the joint embedding network may be warm-started from separate audio and text encoder models. For example, the joint embedding network may include dedicated towers, such as an audio embedding tower to generate an audio embedding, and a text embedding tower to generate a textual embedding. As an illustrative example, the audio embedding tower may include a modified Resnet-50 (e.g., Resnetish-50) architecture trained over a plurality of 64-channel log mel spectrograms. Mel encoding may be performed by converting a signal into a mel-scale magnitude spectrogram and back again using the original input phase. One or more variants of the Mel encoding may be used, such as a narrow band, where the mel bins cover frequencies in a range from 60 to 5000 Hz, and a wide band where the mel bins cover frequencies in a range from 0 to 16,000 Hz. Additional, and/or alternative frequency bands may be utilized. In some embodiments, the audio embedding tower may be pre-trained. In some embodiments, a final classifier layer of the Resnetish-50 architecture may be replaced with a fully connected final layer with a number of units corresponding to a dimension of the shared representation. For example, the fully connected final layer may map to a shared embedding space (e.g., a 64-dimensional space). As another illustrative example, the audio embedding tower may take as input, short clips (e.g., 10-second clips), and apply average pooling on frame-level outputs to produce a single clip-level embedding.

In some embodiments, for the text embedding tower, a publicly available uncased Bidirectional Encoder Representations from Transformers (BERT) based embedding model may be used. As an illustrative example, a transformer architecture based on a special classification token (CLS-token) pooling may be used, with a fully connected final layer to map to the shared representation. CLS is the last hidden state of BERT. For example, the fully connected final layer may map to the shared embedding space (e.g., the 64-dimensional space).

In some embodiments, after initialization of the model, parameters in the audio embedding tower and the text embedding tower may be updated during training. Each batch may be constructed with a preset mix of training data sources. For illustrative purposes, the preset mix may include 30% from the 50M video dataset, 5% from the 50K collected captions dataset, 25% from the AudioCaps dataset, 10% from AudioSet labels dataset, and 30% from the Pro Sound dataset. Other combinations are considered within a general scope of this description. In some embodiments, an optimization of these proportions may not be performed for training. Training losses may be computed over examples across multiple accelerators, leading to an effective batch size (e.g., 6144) of target audio-text pairs. In some embodiments, an Adam optimizer with learning rate 5e-5 may be used, with a trainable softmax temperature with an initial value (e.g., 0.1).

In some embodiments, the joint embedding network includes a symmetric encoder-decoder U-net neural network with skip-connections. For example, the architecture may include a symmetric encoder-decoder U-net network with skip-connections, operating in the waveform domain, where the architecture of the decoder layers mirrors the structure of the encoder, and the skip-connections run between each encoder block and its mirrored decoder block.

### Training Machine Learning Models for Generating Inferences/Predictions

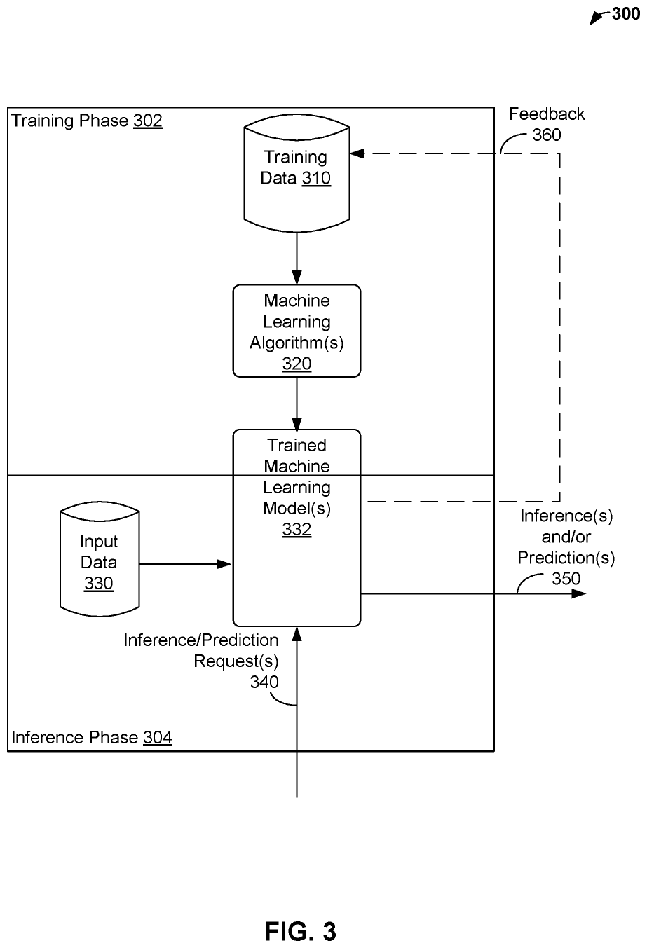

FIG. 3 shows diagram 300 illustrating a training phase 302 (e.g., as illustrated in FIG. 2) and an inference phase 304 (e.g., as illustrated in FIG. 1) of trained machine learning model(s) 332, in accordance with example embodiments. Some machine learning techniques involve training one or more machine learning algorithms on an input set of training data to recognize patterns in the training data and provide output inferences and/or predictions about (patterns in the) training data. The resulting trained machine learning algorithm can be termed a trained machine learning model. For example, FIG. 3 shows training phase 302 where one or more machine learning algorithms 320 are being trained on training data 310 to become trained machine learning model 332. Then, during inference phase 304, trained machine learning model 332 can receive input data 330 (e.g., input audio waveform, input textual description) and one or more inference/prediction requests 340 (perhaps as part of input data 330) and responsively provide as an output one or more inferences and/or predictions 350 (e.g., predict whether an audio track in the input audio waveform corresponds to an input textual description).

As such, trained machine learning model(s) 332 can include one or more models of one or more machine learning algorithms 320. Machine learning algorithm(s) 320 may include, but are not limited to: an artificial neural network (e.g., a herein-described convolutional neural networks, a recurrent neural network, a Bayesian network, a hidden Markov model, a Markov decision process, a logistic regression function, a support vector machine, a suitable statistical machine learning algorithm, and/or a heuristic machine learning system). Machine learning algorithm(s) 320 may be supervised or unsupervised, and may implement any suitable combination of online and offline learning.

In some examples, machine learning algorithm(s) 320 and/or trained machine learning model(s) 332 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 320 and/or trained machine learning model(s) 332. In some examples, trained machine learning model(s) 332 can be trained, reside and execute to provide inferences on a particular computing device, and/or otherwise can make inferences for the particular computing device.

During training phase 302, machine learning algorithm(s) 320 can be trained by providing at least training data 310 as training input using unsupervised, supervised, semi-supervised, and/or weakly supervised learning techniques. Unsupervised learning involves providing a portion (or all) of training data 310 to machine learning algorithm(s) 320 and machine learning algorithm(s) 320 determining one or more output inferences based on the provided portion (or all) of training data 310. Supervised learning involves providing a portion of training data 310 to machine learning algorithm(s) 320, with machine learning algorithm(s) 320 determining one or more output inferences based on the provided portion of training data 310, and the output inference(s) are either accepted or corrected based on correct results associated with training data 310. In some examples, supervised learning of machine learning algorithm(s) 320 can be governed by a set of rules and/or a set of labels for the training input, and the set of rules and/or set of labels may be used to correct inferences of machine learning algorithm(s) 320.

Semi-supervised learning involves having correct labels for part, but not all, of training data 310. During semi-supervised learning, supervised learning is used for a portion of training data 310 having correct results, and unsupervised learning is used for a portion of training data 310 not having correct results. In some examples, machine learning algorithm(s) 320 and/or trained machine learning model(s) 332 can be trained using other machine learning techniques, including but not limited to, incremental learning and curriculum learning.

In some examples, machine learning algorithm(s) 320 and/or trained machine learning model(s) 332 can use transfer learning techniques. For example, transfer learning techniques can involve trained machine learning model(s) 332 being pre-trained on one set of data and additionally trained using training data 310. More particularly, machine learning algorithm(s) 320 can be pre-trained on data from one or more computing devices and a resulting trained machine learning model provided to a particular computing device, where the particular computing device is intended to execute the trained machine learning model during inference phase 304. Then, during training phase 302, the pre-trained machine learning model can be additionally trained using training data 310, where training data 310 can be derived from kernel and non-kernel data of the particular computing device. This further training of the machine learning algorithm(s) 320 and/or the pre-trained machine learning model using training data 310 of the particular computing device's data can be performed using either supervised or unsupervised learning. Once machine learning algorithm(s) 320 and/or the pre-trained machine learning model has been trained on at least training data 310, training phase 302 can be completed. The trained resulting machine learning model can be utilized as at least one of trained machine learning model(s) 332.

In particular, once training phase 302 has been completed, trained machine learning model(s) 332 can be provided to a computing device, if not already on the computing device. Inference phase 304 can begin after trained machine learning model(s) 332 are provided to the particular computing device.

During inference phase 304, trained machine learning model(s) 332 can receive input data 330 and generate and output one or more corresponding inferences and/or predictions 350 about input data 330. As such, input data 330 can be used as an input to trained machine learning model(s) 332 for providing corresponding inference(s) and/or prediction(s) 350 to kernel components and non-kernel components. For example, trained machine learning model(s) 332 can generate inference(s) and/or prediction(s) 350 in response to one or more inference/prediction requests 340. In some examples, trained machine learning model(s) 332 can be executed by a portion of other software. For example, trained machine learning model(s) 332 can be executed by an inference or prediction daemon to be readily available to provide inferences and/or predictions upon request. Input data 330 can include data from the particular computing device executing trained machine learning model(s) 332 and/or input data from one or more computing devices other than the particular computing device.

Input data 330 can include an audio waveform and a textual description of an audio. The audio waveform can include sounds corresponding to various objects.

Inference(s) and/or prediction(s) 350 can include audio and/or text embeddings, predictions, estimated audio tracks, and/or other output data produced by trained machine learning model(s) 332 operating on input data 330 (and training data 310). In some examples, trained machine learning model(s) 332 can use output inference(s) and/or prediction(s) 350 as input feedback 360. Trained machine learning model(s) 332 can also rely on past inferences as inputs for generating new inferences.

An audio separation network, an audio embedding network, a text embedding network, a joint embedding network, a classifier, and so forth, can be examples of machine learning algorithm(s) 320. After training, the trained version of such neural networks can be examples of trained machine learning model(s) 332. In this approach, an example of inference/prediction request(s) 340 can be a request to predict whether an audio track in a single channel audio waveform corresponds to an input text description, and a corresponding example of inferences and/or prediction(s) 350 can be an output indicating the audio track in the single channel audio waveform corresponds to the input text description. In some examples, a given computing device can include the trained neural network 300, perhaps after training the neural network. Then, the given computing device can receive requests to predict whether an audio track in a single channel audio waveform corresponds to an input text description, and use the trained neural network to generate the prediction.

In some examples, two or more computing devices can be used to provide the prediction; e.g., a first computing device can generate and send requests to predict whether an audio track in a single channel audio waveform corresponds to an input text description. Then, the second computing device can use the trained versions of neural networks, perhaps after training, to generate the prediction, and respond to the requests from the first computing device, upon reception of responses to the requests, the first computing device can provide the requested output (e.g., using a user interface and/or a display, a printed copy, an electronic communication, etc.).

### Example Data Network

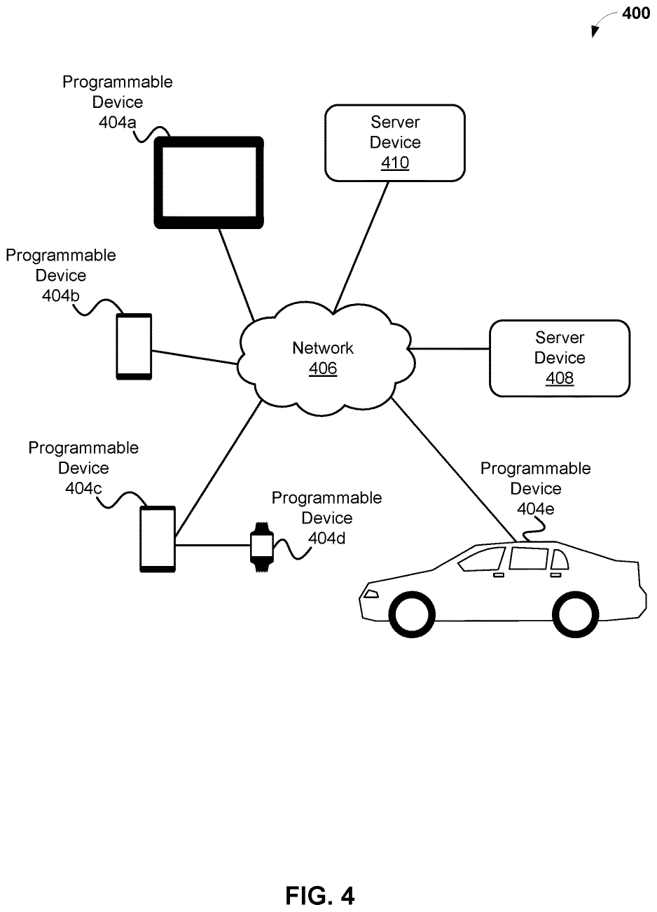

FIG. 4 depicts a distributed computing architecture 400, in accordance with example embodiments. Distributed computing architecture 400 includes server devices 708, 410 that are configured to communicate, via network 406, with programmable devices 404a, 404b, 404c, 404d, 404e. Network 406 may correspond to a local area network (LAN), a wide area network (WAN), a WLAN, a WWAN, a corporate intranet, the public Internet, or any other type of network configured to provide a communications path between networked computing devices. Network 406 may also correspond to a combination of one or more LANs, WANs, corporate intranets, and/or the public Internet.

Although FIG. 4 only shows five programmable devices, distributed application architectures may serve tens, hundreds, or thousands of programmable devices. Moreover, programmable devices 404a, 404b, 404c, 404d, 404e (or any additional programmable devices) may be any sort of computing device, such as a mobile computing device, desktop computer, wearable computing device, head-mountable device (HMD), network terminal, a mobile computing device, and so on. In some examples, such as illustrated by programmable devices 404a, 404b, 404c, 404e, programmable devices can be directly connected to network 406. In other examples, such as illustrated by programmable device 404d, programmable devices can be indirectly connected to network 406 via an associated computing device, such as programmable device 404c. In this example, programmable device 404c can act as an associated computing device to pass electronic communications between programmable device 404d and network 406. In other examples, such as illustrated by programmable device 404e, a computing device can be part of and/or inside a vehicle, such as a car, a truck, a bus, a boat or ship, an airplane, etc. In other examples not shown in FIG. 4, a programmable device can be both directly and indirectly connected to network 406.

Server devices 408, 410 can be configured to perform one or more services, as requested by programmable devices 404a-404e. For example, server device 408 and/or 410 can provide content to programmable devices 404a-404e. The content can include, but is not limited to, web pages, hypertext, scripts, binary data such as compiled software, images, audio, and/or video. The content can include compressed and/or uncompressed content. The content can be encrypted and/or unencrypted. Other types of content are possible as well.

As another example, server device 408 and/or 410 can provide programmable devices 404a-404e with access to software for database, search, computation, graphical, audio, video, World Wide Web/Internet utilization, and/or other functions. Many other examples of server devices are possible as well.

### Computing Device Architecture

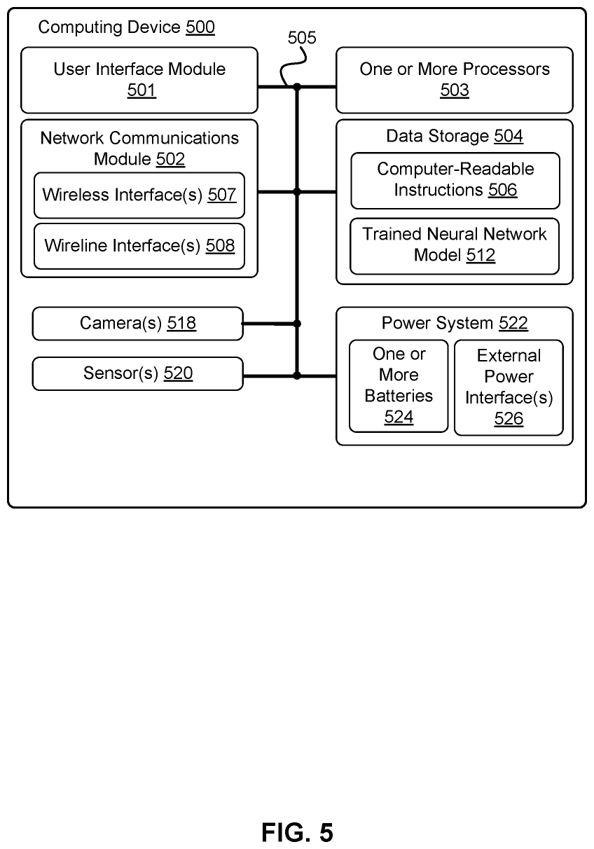

FIG. 5 is a block diagram of an example computing device 500, in accordance with example embodiments. In particular, computing device 500 shown in FIG. 5 can be configured to perform at least one function of and/or related to the neural networks described herein, and/or methods 700, 800.

Computing device 500 may include a user interface module 501, a network communications module 502, one or more processors 503, data storage 504, one or more cameras 518, one or more sensors 520, and power system 522, all of which may be linked together via a system bus, network, or other connection mechanism 505.

User interface module 501 can be operable to send data to and/or receive data from external user input/output devices. For example, user interface module 501 can be configured to send and/or receive data to and/or from user input devices such as a touch screen, a computer mouse, a keyboard, a keypad, a touch pad, a trackball, a joystick, a voice recognition module, and/or other similar devices. User interface module 501 can also be configured to provide output to user display devices, such as one or more cathode ray tubes (CRT), liquid crystal displays, light emitting diodes (LEDs), displays using digital light processing (DLP) technology, printers, light bulbs, and/or other similar devices, either now known or later developed. User interface module 501 can also be configured to generate audible outputs, with devices such as a speaker, speaker jack, audio output port, audio output device, earphones, and/or other similar devices. User interface module 501 can further be configured with one or more haptic devices that can generate haptic outputs, such as vibrations and/or other outputs detectable by touch and/or physical contact with computing device 500. In some examples, user interface module 501 can be used to provide a graphical user interface (GUI) for utilizing computing device 500. For example, user interface module 501 can be used to provide selectable audio tracks, where the selectable audio tracks are separated from an input audio waveform. Also, for example, user interface module 501 can be used to receive user selection of an audio track. In some embodiments, the selected audio track can be enhanced, or suppressed.

Network communications module 502 can include one or more devices that provide one or more wireless interfaces 507 and/or one or more wireline interfaces 508 that are configurable to communicate via a network. Wireless interface(s) 507 can include one or more wireless transmitters, receivers, and/or transceivers, such as a Bluetooth™ transceiver, a Zigbee® transceiver, a Wi-Fi™ transceiver, a WiMAX™ transceiver, an LTE™ transceiver, and/or other type of wireless transceiver configurable to communicate via a wireless network. Wireline interface(s) 508 can include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network.

In some examples, network communications module 502 can be configured to provide reliable, secured, and/or authenticated communications. For each communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information such as cyclic redundancy check (CRC) and/or parity check values). Communications can be made secure (e.g., be encoded or encrypted) and/or decrypted/decoded using one or more cryptographic protocols and/or algorithms, such as, but not limited to, Data Encryption Standard (DES), Advanced Encryption Standard (AES), a Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure (and then decrypt/decode) communications.

One or more processors 503 can include one or more general purpose processors, and/or one or more special purpose processors (e.g., digital signal processors, tensor processing units (TPUs), graphics processing units (GPUs), application specific integrated circuits, etc.). One or more processors 503 can be configured to execute computer-readable instructions 506 that are contained in data storage 504 and/or other instructions as described herein.

Data storage 504 can include one or more non-transitory computer-readable storage media that can be read and/or accessed by at least one of one or more processors 503. The one or more computer-readable storage media can include volatile and/or non-volatile storage components, such as optical, magnetic, organic or other memory or disc storage, which can be integrated in whole or in part with at least one of one or more processors 503. In some examples, data storage 504 can be implemented using a single physical device (e.g., one optical, magnetic, organic or other memory or disc storage unit), while in other examples, data storage 504 can be implemented using two or more physical devices.

Data storage 504 can include computer-readable instructions 506 and perhaps additional data. In some examples, data storage 504 can include storage required to perform at least part of the herein-described methods, scenarios, and techniques and/or at least part of the functionality of the herein-described devices and networks. In some examples, data storage 504 can include storage for a trained neural network model 512 (e.g., a model of trained neural networks such as the networks described in the inference phase 100). In particular of these examples, computer-readable instructions 506 can include instructions that, when executed by processor(s) 503, enable computing device 500 to provide for some or all of the functionality of trained neural network model 512.

In some examples, computing device 500 can include one or more cameras 518. Camera(s) 518 can include one or more image capture devices, such as still and/or video cameras, equipped to capture videos. The one or more images can be one or more images utilized in video imagery. Camera(s) 518 can capture light and/or electromagnetic radiation emitted as visible light, infrared radiation, ultraviolet light, and/or as one or more other frequencies of light.

In some examples, computing device 500 can include one or more sensors 520. Sensors 520 can be configured to measure conditions within computing device 500 and/or conditions in an environment of computing device 500 and provide data about these conditions. For example, sensors 520 can include one or more of: (i) sensors for obtaining data about computing device 500, such as, but not limited to, a thermometer for measuring a temperature of computing device 500, a battery sensor for measuring power of one or more batteries of power system 522, and/or other sensors measuring conditions of computing device 500; (ii) an identification sensor to identify other objects and/or devices, such as, but not limited to, a Radio Frequency Identification (RFID) reader, proximity sensor, one-dimensional barcode reader, two-dimensional barcode (e.g., Quick Response (QR) code) reader, and a laser tracker, where the identification sensors can be configured to read identifiers, such as RFID tags, barcodes, QR codes, and/or other devices and/or object configured to be read and provide at least identifying information; (iii) sensors to measure locations and/or movements of computing device 500, such as, but not limited to, a tilt sensor, a gyroscope, an accelerometer, a Doppler sensor, a GPS device, a sonar sensor, a radar device, a laser-displacement sensor, and a compass; (iv) an environmental sensor to obtain data indicative of an environment of computing device 500, such as, but not limited to, an infrared sensor, an optical sensor, a light sensor, a biosensor, a capacitive sensor, a touch sensor, a temperature sensor, a wireless sensor, a radio sensor, a movement sensor, a microphone, a sound sensor, an ultrasound sensor and/or a smoke sensor; and/or (v) a force sensor to measure one or more forces (e.g., inertial forces and/or G-forces) acting about computing device 500, such as, but not limited to one or more sensors that measure: forces in one or more dimensions, torque, ground force, friction, and/or a zero moment point (ZMP) sensor that identifies ZMPs and/or locations of the ZMPs. Many other examples of sensors 520 are possible as well.

Power system 522 can include one or more batteries 524 and/or one or more external power interfaces 526 for providing electrical power to computing device 500. Each battery of the one or more batteries 524 can, when electrically coupled to the computing device 500, act as a source of stored electrical power for computing device 500. One or more batteries 524 of power system 522 can be configured to be portable. Some or all of one or more batteries 524 can be readily removable from computing device 500. In other examples, some or all of one or more batteries 524 can be internal to computing device 500, and so may not be readily removable from computing device 500. Some or all of one or more batteries 524 can be rechargeable. For example, a rechargeable battery can be recharged via a wired connection between the battery and another power supply, such as by one or more power supplies that are external to computing device 500 and connected to computing device 500 via the one or more external power interfaces. In other examples, some or all of one or more batteries 524 can be non-rechargeable batteries.

One or more external power interfaces 526 of power system 522 can include one or more wired-power interfaces, such as a USB cable and/or a power cord, that enable wired electrical power connections to one or more power supplies that are external to computing device 500. One or more external power interfaces 526 can include one or more wireless power interfaces, such as a Qi wireless charger, that enable wireless electrical power connections, such as via a Qi wireless charger, to one or more external power supplies. Once an electrical power connection is established to an external power source using one or more external power interfaces 526, computing device 500 can draw electrical power from the external power source the established electrical power connection. In some examples, power system 522 can include related sensors, such as battery sensors associated with the one or more batteries or other types of electrical power sensors.

### Cloud-Based Servers

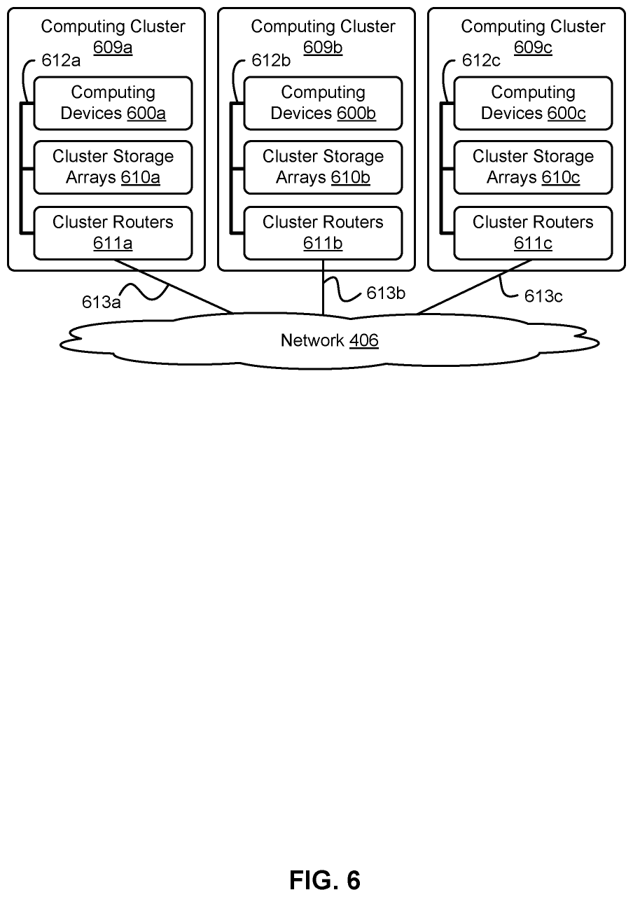

FIG. 6 depicts a network 406 of computing clusters 609a, 609b, 609c arranged as a cloud-based server system in accordance with an example embodiment. Computing clusters 609a, 609b, 609c can be cloud-based devices that store program logic and/or data of cloud-based applications and/or services; e.g., perform at least one function of and/or related to the neural networks, and/or methods 700, 800.

In some embodiments, computing clusters 609a, 609b, 609c can be a single computing device residing in a single computing center. In other embodiments, computing clusters 609a, 609b, 609c can include multiple computing devices in a single computing center, or even multiple computing devices located in multiple computing centers located in diverse geographic locations. For example, FIG. 6 depicts each of computing clusters 609a, 609b, and 609c residing in different physical locations.

In some embodiments, data and services at computing clusters 609a, 609b, 609c can be encoded as computer readable information stored in non-transitory, tangible computer readable media (or computer readable storage media) and accessible by other computing devices. In some embodiments, computing clusters 609a, 609b, 609c can be stored on a single disk drive or other tangible storage media, or can be implemented on multiple disk drives or other tangible storage media located at one or more diverse geographic locations.

FIG. 6 depicts a cloud-based server system in accordance with an example embodiment. In FIG. 6, functionality of the neural networks, and/or a computing device can be distributed among computing clusters 609a, 609b, 609c. Computing cluster 609a can include one or more computing devices 600a, cluster storage arrays 610a, and cluster routers 611a connected by a local cluster network 612a. Similarly, computing cluster 609b can include one or more computing devices 600b, cluster storage arrays 610b, and cluster routers 611b connected by a local cluster network 612b. Likewise, computing cluster 609c can include one or more computing devices 600c, cluster storage arrays 610c, and cluster routers 611c connected by a local cluster network 612c.

In some embodiments, each of computing clusters 609a, 609b, and 609c can have an equal number of computing devices, an equal number of cluster storage arrays, and an equal number of cluster routers. In other embodiments, however, each computing cluster can have different numbers of computing devices, different numbers of cluster storage arrays, and different numbers of cluster routers. The number of computing devices, cluster storage arrays, and cluster routers in each computing cluster can depend on the computing task or tasks assigned to each computing cluster.

In computing cluster 609a, for example, computing devices 600a can be configured to perform various computing tasks of a neural network, a text embedding tower, an audio embedding tower, a joint embedding network, an audio separation network, a classifier, and/or a computing device. In one embodiment, the various functionalities of a neural network, a text embedding tower, an audio embedding tower, a joint embedding network, an audio separation network, a classifier, and/or a computing device can be distributed among one or more of computing devices 600a, 600b, 600c. Computing devices 600b and 600c in respective computing clusters 609b and 609c can be configured similarly to computing devices 600a in computing cluster 609a. On the other hand, in some embodiments, computing devices 600a, 600b, and 600c can be configured to perform different functions.

In some embodiments, computing tasks and stored data associated with a neural network, a text embedding tower, an audio embedding tower, a joint embedding network, an audio separation network, a classifier, and/or a computing device can be distributed across computing devices 600a, 600b, and 600c based at least in part on the processing requirements of a neural network, a text embedding tower, an audio embedding tower, a joint embedding network, an audio separation network, a classifier, and/or a computing device, the processing capabilities of computing devices 600a, 600b, 600c, the latency of the network links between the computing devices in each computing cluster and between the computing clusters themselves, and/or other factors that can contribute to the cost, speed, fault-tolerance, resiliency, efficiency, and/or other design goals of the overall system architecture.

Cluster storage arrays 610a, 610b, 610c of computing clusters 609a, 609b, 609c can be data storage arrays that include disk array controllers configured to manage read and write access to groups of hard disk drives. The disk array controllers, alone or in conjunction with their respective computing devices, can also be configured to manage backup or redundant copies of the data stored in the cluster storage arrays to protect against disk drive or other cluster storage array failures and/or network failures that prevent one or more computing devices from accessing one or more cluster storage arrays.

Similar to the manner in which the functions of a neural network, a text embedding tower, an audio embedding tower, a joint embedding network, an audio separation network, a classifier, and/or a computing device can be distributed across computing devices 600a, 600b, 600c of computing clusters 609a, 609b, 609c, various active portions and/or backup portions of these components can be distributed across cluster storage arrays 610a, 610b, 610c. For example, some cluster storage arrays can be configured to store one portion of the data of a neural network, a text embedding tower, an audio embedding tower, a joint embedding network, an audio separation network, a classifier, and/or a computing device, while other cluster storage arrays can store other portion(s) of data of a neural network, a text embedding tower, an audio embedding tower, a joint embedding network, an audio separation network, a classifier, and/or a computing device. Also, for example, some cluster storage arrays can be configured to store the data of a first neural network, while other cluster storage arrays can store the data of a second and/or third neural network. Additionally, some cluster storage arrays can be configured to store backup versions of data stored in other cluster storage arrays.

Cluster routers 611a, 611b, 611c in computing clusters 609a, 609b, 609c can include networking equipment configured to provide internal and external communications for the computing clusters. For example, cluster routers 611a in computing cluster 609a can include one or more internet switching and routing devices configured to provide (i) local area network communications between computing devices 600a and cluster storage arrays 610a via local cluster network 612a, and (ii) wide area network communications between computing cluster 609a and computing clusters 609b and 609c via wide area network link 613a to network 406. Cluster routers 611b and 611c can include network equipment similar to cluster routers 611a, and cluster routers 611b and 611c can perform similar networking functions for computing clusters 609b and 609b that cluster routers 611a perform for computing cluster 609a.

In some embodiments, the configuration of cluster routers 611a, 611b, 611c can be based at least in part on the data communication requirements of the computing devices and cluster storage arrays, the data communications capabilities of the network equipment in cluster routers 611a, 611b, 611c, the latency and throughput of local cluster networks 612a, 612b, 612c, the latency, throughput, and cost of wide area network links 613a, 613b, 613c, and/or other factors that can contribute to the cost, speed, fault-tolerance, resiliency, efficiency and/or other design criteria of the moderation system architecture.

### Example Methods of Operation

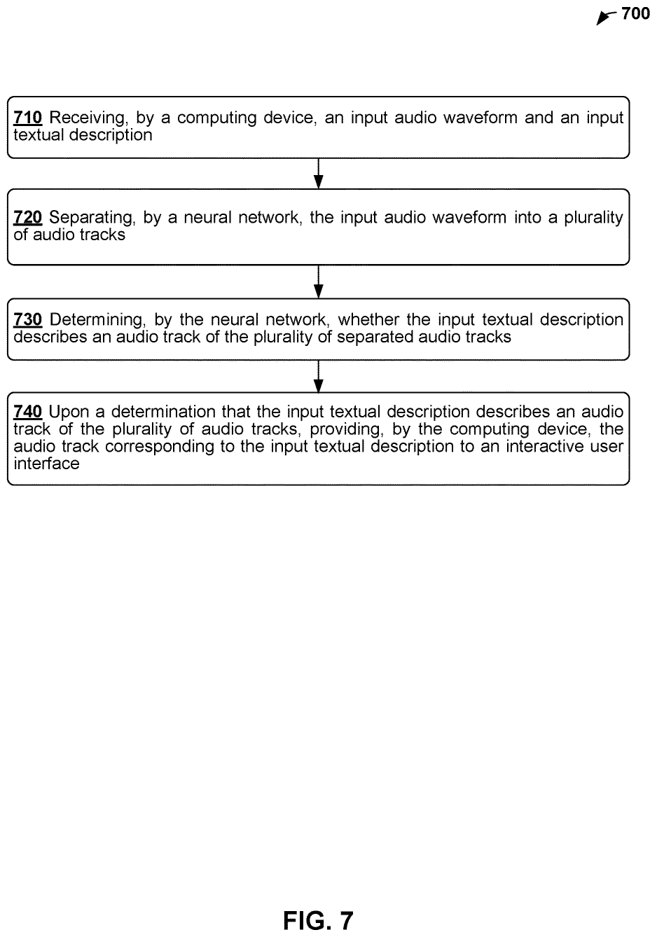

FIG. 7 is a flowchart of a method 700, in accordance with example embodiments.

Method 700 can be executed by a computing device, such as computing device 500. Method 700 can begin at block 710, where the computing device can receive an input audio waveform and an input textual description.

At block 720, the computing device can separate, by a neural network, the input audio waveform into a plurality of audio tracks.

At block 730, the computing device can determine, by the neural network, whether the input textual description describes an audio track of the plurality of separated audio tracks.

At block 740, the computing device can, upon a determination that the input textual description describes an audio track of the plurality of audio tracks, provide the audio track corresponding to the input textual description to an interactive user interface.

In some embodiments, the neural network includes a symmetric encoder-decoder U-net neural network with skip-connections.

In some embodiments, method involves generating, by the neural network, one or more audio embeddings corresponding to the one or more separated audio tracks, wherein the one or more audio embeddings comprise a representation of audio features of the one or more separated audio tracks. Such embodiments also involve generating, by the neural network, a text embedding corresponding to the input textual description, wherein the text embedding comprises a representation of textual features of the input textual description, and wherein the determining of whether the input textual description describes an audio track of the plurality of audio tracks comprises applying a classifier to match the one or more audio embeddings to the text embedding.

In some embodiments, the neural network includes an audio separation network to perform the separating of the input audio waveform into the plurality of audio tracks, an audio embedding network to generate the one or more audio embeddings, and a text embedding network to generate the text embedding.

In some embodiments, the neural network includes a joint embedding network, and the method involves generating, by the joint embedding network, a text embedding of the input textual description, and respective audio embeddings of the plurality of audio tracks, into a shared representation comprising a joint embedding, wherein a particular audio embedding is within a threshold distance of a particular text embedding that describes the particular audio embedding. In some embodiments, the joint embedding network includes an audio embedding tower to generate the audio embedding, and a text embedding tower to generate the textual embedding.

In some embodiments, the audio embedding tower includes (a) a modified Resnet-50 architecture trained over a plurality of 64-channel log mel spectrograms, and (b) a fully connected final layer with a number of units corresponding to a dimension of the shared representation.

In some embodiments, the text embedding tower includes (a) a Bidirectional Encoder Representations from Transformers (BERT)-base transformer architecture based on special classification token (CLS-token) pooling, and (b) a fully connected final layer to map to the shared representation.

Some embodiments involve receiving training data comprising a plurality of audio tracks, wherein each audio track of the plurality of audio tracks is labeled with a text caption associated with the audio track. Such embodiments involve training, based on the training data, the neural network.

In some embodiments, the neural network includes an audio separation network to perform the separating of the input audio waveform into the plurality of audio tracks, and wherein the training of the audio separation network comprises unsupervised mixture invariant training.

In some embodiments, the neural network includes a classifier configured to determine whether the input textual description describes an audio track of the plurality of separated audio tracks, and wherein the training of the neural network is based on a matching loss for the classifier, and wherein the matching loss is indicative of a degree of matching of a textual description to a given audio track in a given audio waveform.

In some embodiments, the training of the neural network is performed at the computing device.

In some embodiments, the receiving of the input audio waveform and the input textual description involves receiving the input textual description from a user via the interactive user interface.

In some embodiments, the providing of the audio track involves providing, by the interactive user interface, a user selectable option to enhance or suppress the audio track corresponding to the input textual description.

Some embodiments involve generating, by the computing device, a request to determine whether the input textual description describes an audio track of the plurality of audio tracks. Such embodiments involve sending the request from the computing device to a second computing device, the second computing device comprising a trained version of the neural network. Such embodiments also involve, after sending the request, the computing device receiving, from the second computing device, the determining of whether the input textual description describes an audio track of the plurality of audio tracks. Such embodiments further involve outputting the audio track corresponding to the input textual description based on the received determination of the input textual description describes an audio track of the plurality of audio tracks.

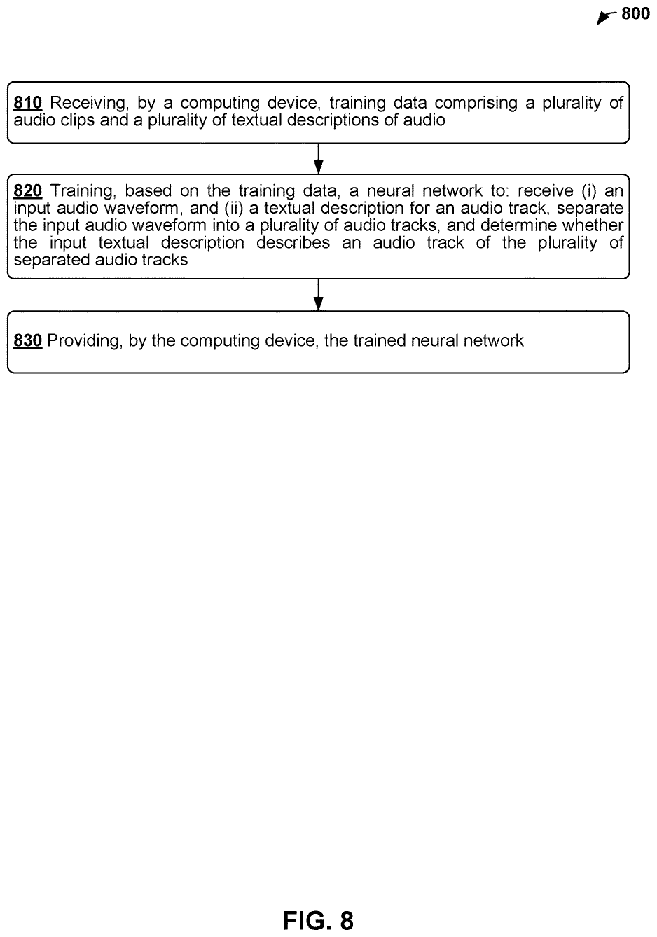

FIG. 8 is a flowchart of a method 800, in accordance with example embodiments. Method 800 can be executed by a computing device, such as computing device 500. Method 800 can begin at block 810, where the computing device can receive training data comprising a plurality of audio clips and a plurality of textual descriptions of audio.

At block 820, the computing device can train, based on the training data, a neural network to receive (i) an input audio waveform, and (ii) a textual description for an audio track, separate the input audio waveform into a plurality of audio tracks, and determine whether the input textual description describes an audio track of the plurality of separated audio tracks.

At block 830, the computing device can provide the trained neural network.

In some embodiments, the training of the neural network is performed at the computing device.

In some embodiments, the neural network includes an audio separation network to perform the separating of the input audio waveform into the plurality of audio tracks, and a classifier configured to determine whether the input textual description describes an audio track of the plurality of separated audio tracks.

In some embodiments, the training of the neural network involves unsupervised mixture invariant training of the audio separation network.

In some embodiments, the training of the neural network is based on a matching loss to train the classifier, wherein the matching loss is indicative of a degree of matching of a textual description to a given audio track in a given audio waveform.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as non-transitory computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

While various aspects and embodiments have been disclosed herein, other aspects and embodiments will be apparent to those skilled in the art. The various aspects and embodiments disclosed herein are provided for explanatory purposes and are not intended to be limiting, with the true scope being indicated by the following claims.

1. A computer-implemented method, comprising:
receiving, by a computing device, an input audio waveform and an input textual description;
separating, by a neural network, the input audio waveform into a plurality of audio tracks;
determining, by the neural network, whether the input textual description describes an audio track of the plurality of separated audio tracks; and
upon a determination that the input textual description describes an audio track of the plurality of audio tracks, providing, by the computing device, the audio track corresponding to the input textual description to an interactive user interface.

2. The computer-implemented method of claim 1, wherein the neural network comprises a symmetric encoder-decoder U-net neural network with skip-connections.

3. The computer-implemented method of claim 1, further comprising:
generating, by the neural network, one or more audio embeddings corresponding to the one or more separated audio tracks, wherein the one or more audio embeddings comprise a representation of audio features of the one or more separated audio tracks;
generating, by the neural network, a text embedding corresponding to the input textual description, wherein the text embedding comprises a representation of textual features of the input textual description, and
wherein the determining of whether the input textual description describes an audio track of the plurality of audio tracks comprises applying a classifier to match the one or more audio embeddings to the text embedding.

4. The computer-implemented method of claim 3, wherein the neural network comprises:
an audio separation network to perform the separating of the input audio waveform into the plurality of audio tracks;
an audio embedding network to generate the one or more audio embeddings; and
a text embedding network to generate the text embedding.

5. The computer-implemented method of claim 1, wherein the neural network comprises a joint embedding network, and further comprising:
generating, by the joint embedding network, a text embedding of the input textual description, and respective audio embeddings of the plurality of audio tracks, into a shared representation comprising a joint embedding, wherein a particular audio embedding is within a threshold distance of a particular text embedding that describes the particular audio embedding.

6. The computer-implemented method of claim 5, wherein the joint embedding network comprises an audio embedding tower to generate the audio embedding, and a text embedding tower to generate the textual embedding.

7. The computer-implemented method of claim 6, wherein the audio embedding tower comprises (a) a modified Resnet-50 architecture trained over a plurality of 64-channel log mel spectrograms, and (b) a fully connected final layer with a number of units corresponding to a dimension of the shared representation.

8. The computer-implemented method of claim 6, wherein the text embedding tower comprises (a) a Bidirectional Encoder Representations from Transformers (BERT)-base transformer architecture based on special classification token (CLS-token) pooling, and (b) a fully connected final layer to map to the shared representation.

9. The computer-implemented method of claim 1, further comprising:
receiving training data comprising a plurality of audio tracks, wherein each audio track of the plurality of audio tracks is labeled with a text caption associated with the audio track; and
training, based on the training data, the neural network.

10. The computer-implemented method of claim 9, wherein the neural network comprises an audio separation network to perform the separating of the input audio waveform into the plurality of audio tracks, and wherein the training of the audio separation network comprises unsupervised mixture invariant training.

11. The computer-implemented method of claim 9, wherein the neural network comprises a classifier configured to determine whether the input textual description describes an audio track of the plurality of separated audio tracks, and wherein the training of the neural network is based on a matching loss for the classifier, and wherein the matching loss is indicative of a degree of matching of a textual description to a given audio track in a given audio waveform.

12. The computer-implemented method of claim 9, wherein the training of the neural network is performed at the computing device.

13. The computer-implemented method of claim 1, wherein the receiving of the input audio waveform and the input textual description comprises receiving the input textual description from a user via the interactive user interface.

14. The computer-implemented method of claim 1, wherein the providing of the audio track comprises providing, by the interactive user interface, a user selectable option to enhance or suppress the audio track corresponding to the input textual description.

15. A computer-implemented method, comprising:
receiving, by a computing device, training data comprising a plurality of audio clips and a plurality of textual descriptions of audio;
training, based on the training data, a neural network to:
receive (i) an input audio waveform, and (ii) a textual description for an audio track,
separate the input audio waveform into a plurality of audio tracks, and
determine whether the input textual description describes an audio track of the plurality of separated audio tracks; and
providing, by the computing device, the trained neural network.

16. The computer-implemented method of claim 15, wherein the training of the neural network is performed at the computing device.

17. The computer-implemented method of claim 15, wherein the neural network comprises:
an audio separation network to perform the separating of the input audio waveform into the plurality of audio tracks; and
a classifier configured to determine whether the input textual description describes an audio track of the plurality of separated audio tracks.

18. The computer-implemented method of claim 17, wherein the training of the neural network comprises unsupervised mixture invariant training of the audio separation network.

19. The computer-implemented method of claim 17, wherein the training of the neural network is based on a matching loss to train the classifier, wherein the matching loss is indicative of a degree of matching of a textual description to a given audio track in a given audio waveform.

20. A computing device, comprising:
one or more processors; and
data storage, wherein the data storage has stored thereon computer-executable instructions that, when executed by the one or more processors, cause the computing device to carry out operations comprising:
receiving, by a computing device, an input audio waveform and an input textual description;
separating, by a neural network, the input audio waveform into a plurality of audio tracks;
determining, by the neural network, whether the input textual description describes an audio track of the plurality of separated audio tracks; and
upon a determination that the input textual description describes an audio track of the plurality of audio tracks, providing, by the computing device, the audio track corresponding to the input textual description to an interactive user interface.
